(19) United States
(12) Patent Application Publication
(10) Pub. No.: US 2009/0164576 A1
(43) Pub. Date: Jun. 25, 2009

(54) METHODS AND SYSTEMS FOR PEER-TO-PEER SYSTEMS

(76) Inventors: Jeonghun Noh, Palo Alto, CA (US); Pierpaolo Baccichet, Stanford, CA (US); Bernd Girod, Stanford, CA (US)

Correspondence Address: CRAWFORD MAUNU PLLC, 1150 NORTHLAND DRIVE, SUITE 100, ST. PAUL, MN, 55120, US

(21) Appl. No.: 12/334,947

(22) Filed: Dec. 15, 2008

Related U.S. Application Data
(60) Provisional application No. 61/015,805, filed on Dec. 21, 2007.

(51) Int. Cl. G06F 15/16

(52) U.S. Cl. 709/204; 709/227

(57) ABSTRACT

A variety of methods, systems, devices and configured storage devices are used in relation to peer-to-peer streaming system with a plurality of processing-circuit-peer nodes sharing streaming data by passing the streaming data from parent nodes to child nodes. According to one such system, computer-based nodes are configured and adapted to detect a departure of a first child peer node from the peer-to-peer streaming system. The first child peer node having been a child peer node of the parent peer node and the first child peer having provided data to one or more additional child peers. Responsive to the detected departure, a second child peer is selected to provide data to the one or more additional child peers. Data is provided to the second child peer to facilitate establishment of a connection between the selected child peer and the one or more additional child peers and the parent peer node.

### RELATED PATENT DOCUMENTS

This is a conversion of U.S. Provisional Patent Application Ser. No. 60/015,805, entitled “Methods and Systems for Peer-to-Peer Systems,” and filed on Dec. 21, 2007, to which benefit is claimed under 35 U.S.C. §119.

### FIELD OF THE INVENTION

The present invention relates generally to peer-to-peer systems and methods, and more particularly to arrangements and approaches for an overlay topology of a peer-to-peer streaming system.

### OVERVIEW

The various protocols and algorithms discussed herein dynamically and actively change the overlay topology of any existing peer-to-peer (P2P) system. The protocols and algorithms can be particularly useful for improving the total system capacity, data transmission delay to individual peers, or system robustness. In peer-to-peer systems, peers are the devices of the network end users, such as laptops, desktop computers and mobile phones. They form an overlay topology by interacting with each other in order to distribute data among themselves.

Various embodiments of this invention allow peers to be equipped with a set of protocols and algorithms that change the overlay topology in a distributed way, thus providing good scalability to the system as well as improving the overlay topology.

Various embodiments involve the use of different protocols that are used to determine the relations among peers or how communication among peers is carried out while performing various operations related to peer-to-peer sharing. Some algorithms determine when and how Active Management operations are initiated and executed among a set of peers. Such algorithms can perform the determinations in a distributed fashion. The determinations are used by peers in the P2P system to form an overlay topology over the underlying physical network, thereby creating data distribution structures among themselves. These structures are used to deliver contents such as files and multimedia from the source that creates or owns the contents to participating peers.

In one embodiment, the algorithms are performed within distributed P2P systems. Other embodiments involve the application of the algorithms in centralized P2P systems.

The above overview is not intended to describe each illustrated embodiment or every implementation of the present invention.

### BRIEF DESCRIPTION OF THE DRAWINGS

The present invention is directed to overcoming the above-mentioned challenges and others related to the types of applications discussed herein. These and other aspects of the present invention are exemplified in a number of illustrated implementations and applications, some of which are shown and discussed in connection with the figures and, to some extent, characterized in the claims section that follows. Various embodiments of the invention are presented in connection with the accompanying drawings, in which:

FIG. 1 shows an example P2P network, consistent with an example embodiment of the present invention;

FIG. 2 depicts a flowchart for implementing a swapping operation, according to one embodiment of the present invention,

FIG. 3 depicts a flowchart for implementing a reordering operation, according to one embodiment of the present invention, and

FIG. 4 depicts a flowchart for implementing an adoption operation, according to one embodiment of the present invention.

While the invention is amenable to various modifications and alternative forms, examples thereof have been shown by way of example in the drawings and will be described in detail. It should be understood, however, that the intention is not to limit the invention to the particular embodiments shown and/or described. On the contrary, the intention is to cover all modifications, equivalents, and alternatives falling within the spirit and scope of the invention.

### DETAILED DESCRIPTION

The present invention is believed to be applicable to a variety of different types of processes, devices and arrangements for P2P networks, for example distributed P2P networks for providing steaming content. The skilled artisan will appreciated that P2P networks can be implemented a variety of computer-based communication arrangements providing connectivity between participants in a network and typically involving computers and/or servers as “nodes” for receiving/transmitting packets. While the present invention is not necessarily so limited, various aspects of the invention may be appreciated through a discussion of examples using this context.

Various embodiments of the invention can be implemented to allow a pair of peers to swap positions. Distributed algorithms (or processes) are used to improve the system capacity and reduce end-to-end transmission delay of data packets, respectively.

In one embodiment peer replacement (adoption) is performed at the source of a streaming content. The peer selection and replacement mechanism facilitates the use of the upload capacity of the source. The details of these and other operations are described below in more detail, including examples of specific protocols and Algorithms 1-3, which are presented as nonlimiting examples in support of certain embodiments.

The peers upload (uplink) capacity, which can be based upon the underlying physical access network, determines their ability to contribute to the P2P system. However, some peers may have capacity that is not sufficient to fully support other peers or simply not enough to support enough additional peers. A peer that does not contribute to the system or contributes with a limited capacity, but that nevertheless receives the whole video, is called a leech peer. Since leech peers do not forward a sufficient amount of data to other peers, they can be seen as blocking/hampering the data flow from the source to other peers.

In one embodiment of the present invention, a performance metric, such as threshold peer uplink capacity (Cₜₕᵣₑₛ), latency or reliability is set by the system in order to allow a peer to check whether its performance is above the threshold and hence is able to sufficiently contribute to the system. For simplicity, the following discussion assumes that the performance metric is peer uplink capacity; however, various other metrics are also possible.

Peers wishing to join the overlay compare their uplink capacity to Cₜₕᵣₑₛ. Peers below Cₜₕᵣₑₛ (leech peers) are given lesser priority. In a specific example, leech peers are only allowed to join when the system has a sufficient extra capacity. One way to measure sufficient capacity is to determine whether any of the existing peers would be adversely affected by the addition of the leech peer. For example, if the addition of the peer would prevent another peer from receiving sufficient bandwidth to display the streaming content or result in unacceptable delay in the delivery time of streaming data to another peer.

Once a peer joins the system, peer's uplink capacity is used to forward data packets to other peers, forming a path from the source to each peer. In a specific overlay system, each path consists of one or more unicast connections, each of which is a one-to-one connection between a pair of peers at the network layer, either between the source and a peer, or between a pair of peers. On each path, a peer that forwards data packets is called a parent peer, and a peer that receives the packets is called a child peer.

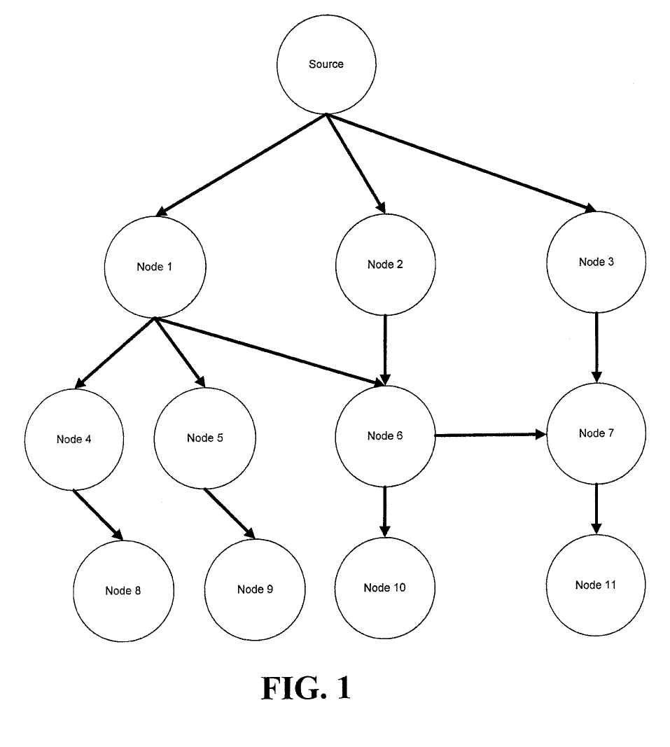

FIG. 1 shows an example P2P network, consistent with an example embodiment of the present invention. The source node provides streaming data to one or more peer nodes. In FIG. 1, the source node provides streaming data to nodes 1-3. Nodes 1-3 are able to receive data at a rate commensurate with the lesser of their download capacity and the uplink capacity provided to them by the source. Nodes 1-3 then provide streaming data to nodes 4-7. In this example, Nodes 1-3 are parents of nodes 4-7, which are children of the respective ones of nodes 1-3. The nodes need not follow a strict tree type topology as nodes at the same level from the source can share between themselves. For example, node 7 is shown as a child of both nodes 3 and 6. Nodes 8-11 are shown as having no child nodes. Contingent on their uplink capacity, these nodes would generally be able to accept new nodes that wish to join the network. The network need not be limited to a single source node, although for live streaming video it can be useful to have either a single source or synchronization between the sources.

One embodiment of the present invention involves a peer swapping operation that is performed by newly joining peers in a distributed manner. The swap operation involves categorizing peers as leech peers and prioritizing their acceptance in the overlay system accordingly. When a new peer is requesting to be added to the system, the system determines whether there is sufficient capacity to support a new peer. If there is sufficient capacity, the peer can be allowed to join. If there is not sufficient capacity, the peer's categorization as a leech peer is used as part of the algorithm. A new peer that is categorized as a leech peer is not permitted to join a system that does not have sufficient capacity. The new peer with an uplink capacity greater than or equal to Cₜₕᵣₑₛ searches for a leech peer. Upon finding a leech peer, the new peer contacts the parent of one of the leech peers and requests a swap of positions between itself and the leech peer. Once this swapping is completed, the new peer becomes part of the system. By replacing a non-contributing or minimally contributing peer with a contributing peer this process can be useful for increasing the effective system capacity. Specifically, the system capacity can theoretically be increased by the difference between the new peer's uplink capacity and the replaced leech peers uplink capacity.

The network protocols used for this algorithm involve three peers including a new peer P_{N}, a leech peer P_{L}, and the parent of the leech peer Pp. First, P_{N} contacts the video source, S, to receive a fraction of the list of all participating peers. Once the list is received, P_{N} probes peers identified in the list. When no peer with available capacity is found, P_{N} decides the next action responsive to its own capacity. If the capacity is below Cₜₕᵣₑₛ, then P_{N 0}is classified as a leech peer and is not allowed to join the system. If P_{N}'s capacity is above Cₜₕᵣₑₛ, then it uses Algorithm 1 to select one of the leech peers (P_{L}) that have responded with to probes from P_{N}. If no leech peers have been found, P_{N} can contact S to obtain a new list of peers to probe again and it repeats this probing until it finds a P_{L}. P_{N} then contacts the parent of P_{L}, P_{P}, to request swapping between P_{L} and P_{N}. When P_{P} receives a Swap request from P_{N}, it stops forwarding data to its old child peer, P_{L}, and starts forwarding data to its new child peer, P_{N}. To signal its acceptance to P_{N}, P_{P} sends an attachment acceptance message to P_{N}. When P_{N} receives the acceptance message, it sends a Swap notice to P_{L} and starts forwarding data to P_{L}.

Cₜₕᵣₑₛ can be set according to a number of factors. One acceptable value that can be used as a baseline is the minimum value necessary to support at least one other peer node. This assures that any new node is providing as much to the system as it is receiving. This value, however, may not be ideal for all systems. For example, a system may include relatively few nodes with very high uplink capacities, a large number of nodes with medium uplink capacities and any number of nodes with little or no capacity. It may be the case that the nodes with medium uplink capacities generally have less uplink capacity than is necessary to fully support at least one other node.

Even so, the system may still be able to provide service to all of the nodes with medium uplink capacities (e.g., due to the nodes with high uplink capacities and/or for network topologies that allow for nodes to have multiple parents). For such a case, the threshold can be selected to include the medium capacity nodes, while excluding the low capacity nodes.

In certain instances, it may also be possible to implement a tiered threshold capacity check. This can be useful for effectively allowing the system to shift the cutoff threshold capacity for addition to the system. If enough granularity is provided in the tiered system, a new peer node attempting to add to the system can essentially add itself to the system whenever it provides more capacity than the lowest currently participating node by replacing the lowest participating node.

Algorithm 1:

Require: C ≧ Cₜₕᵣₑₛ, C is the uplink capacity
of the peer running this algorithm
Require: cᵢ := Uplink capacity of a leech peer i
n := Number of probe replies
dᵢ := The number of logical hops from the source to a leech peer i
ChosenPeer = 0
Lₘᵢₙ 00
i 1
while i ≧ n do
if Lₘᵢₙ > dᵢ and Cᵢ <Cₜₕᵣₑₛ then
ChosenPeer i
Lₘᵢₙ dᵢ,
end if
end while
return ChosenPeer

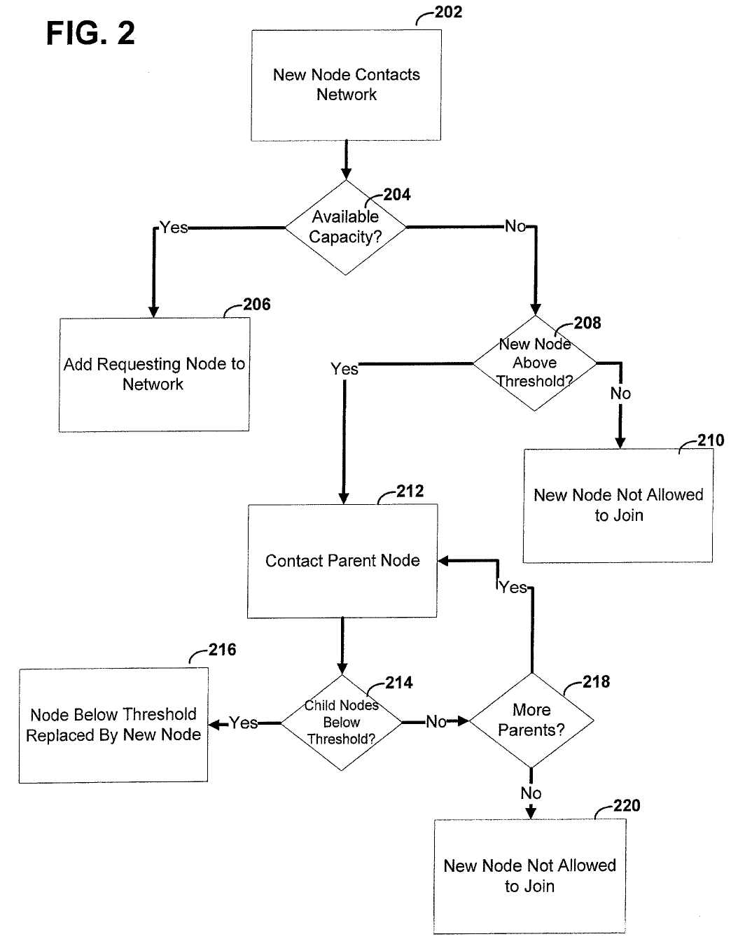

FIG. 2 depicts a flowchart for implementing such a swapping operation, according to one embodiment of the present invention. Block 202 represents a new node wishing to join the network. A first decision is made at block 204 as to whether the system has sufficient capacity to accept a new node. This decision can be made, for example, at each node of the system. The decision may be a local decision (e.g., whether the particular contacted node has sufficient uplink capacity) or a global decision (e.g., whether any node in the system has sufficient uplink capacity). In a particular instance, the global decision can be facilitated by allowing a node with sufficient capacity to communicate/broadcast its availability to other nodes in the network. For the local decision, the new node can contact additional nodes in the network. A similar local decision can be made for the newly contacted nodes. If sufficient capacity is found, the new node can be added to the system as shown by block 206. If sufficient capacity is not found, a decision is made at block 208 as to whether the new node has uplink capacity that is above a threshold capacity. If the new node is not above the threshold capacity, the new node is not allowed to join the network as shown by block 210. If the new node is above the threshold capacity, then block 212 shows the new node contacting parent nodes. At block 214, a decision is made as to whether the contacted parent node has a child node with a capacity that is below the threshold capacity (i. e., a leech peer node). If the decision is positive, the leech peer node is replaced by the new node at block 216. If the decision is negative, a decision is made as to whether there are additional parent nodes to be contacted at block 218. If there are one or more additional parent nodes, the process can repeat from block 212. If no additional parent nodes exist, the new node is not allowed to join the network as shown by block 220.

One embodiment of the present invention involves a peer swapping operation that is performed between already participating peers in a distributed way. Peers participating in the system may be heterogeneous in their uplink capacity. Peers with high uplink capacity generally require less time to forward a data packet to child peers when compared to the time peers with low uplink capacity require to forward a data packet having the same size. When a parent peer finds a child peer that has higher capacity than its own capacity, they swap positions to reduce average end-to-end transmission delay of data packets. In order to maintain stability, peers performing the swap operation can maintain their child peers during the swap.

The network protocols used for this algorithm involve three peers including a parent peer P_{P}, a child peer P_{C}, and the parent of P_{P}, P_{GP}. P_{GP} is also the grandparent of P_{C}. Each peer periodically checks all of its children to find a peer with a larger capacity than it has itself. Suppose at a certain time t, a peer P_{P}has decided to swap positions with one of its child peers, P_{C}, selected by using Algorithm 2. P_{P} first sends a Swap request to P_{C}. If P_{C} has as much capacity as is needed to accept P_{P} as its new child peer, then it first reserves that amount of its capacity for P_{P}and sends a Swap reply to P_{P}. Next, P_{C} sends a Swap-B request to P_{GP}. P_{GP} then disconnects P_{P} and accepts P_{C} as a new child. When P_{GP} receives the request, it stops forwarding data to P_{P} and starts forwarding data to P_{C}. To signal that the request has been processed, P_{GP} sends a confirmation message to P_{C}. When P_{C} receives the message from P_{GP}, it sends a Swap completion message to P_{P} and starts forwarding data to P_{P} by using the reserved capacity.

Algorithm 2:

C := The capacity of Peer X running this algorithm
cᵢ := Uplink capacity of a child peer i of Peer X
n_{c} := The number of Peer X’s child peers
Cmax max_{k=1,...,nc} Cₖ
ChosenPeer arg max_{k=1,...,nc} Cₖ
If C ≧ Cₘₐₓ then
ChosenPeer 0
end if
return ChosenPeer

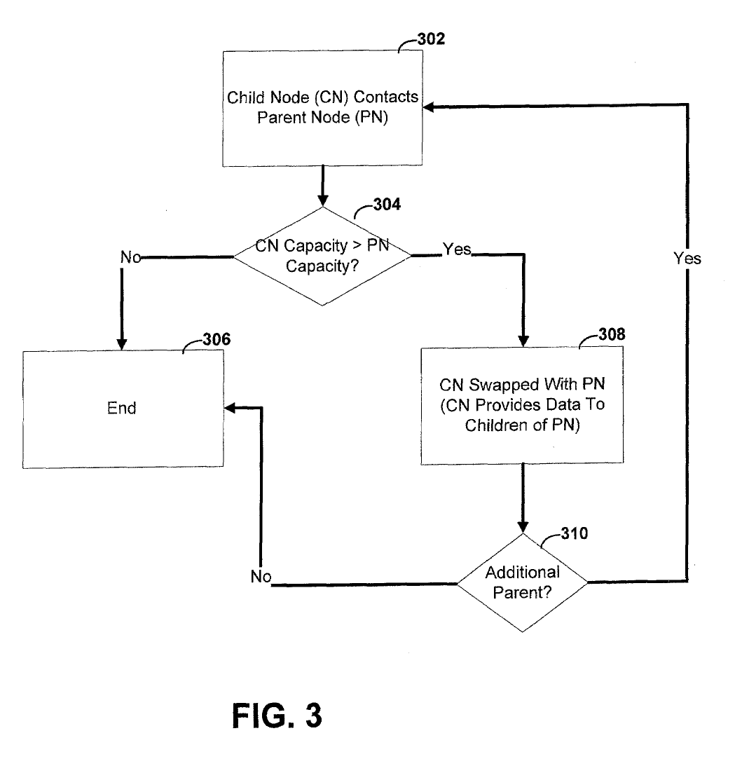

FIG. 3 depicts a flowchart for implementing such a reordering operation, according to one embodiment of the present invention. The steps shown by blocks 302-310 can be performed in a distributed fashion by all nodes in the network or only by a subset of nodes in the system. The steps allow for a node with high uplink capacity to propagate toward the source of the streaming data and for a node with low uplink capacity to propagate further from the source. At block 302, a child node contacts its parent node. In another instance, a parent node can contact each of its child nodes with the remaining operations operating much the same for either instance (e.g., with a parent having low uplink capacity propagating away from the source according to algorithm 2). A comparison is performed between the uplink capacities of the parent and child nodes as shown by block 304. If the uplink capacity of the parent node is greater than the uplink capacity of the child node, no swap is performed as shown by block 306. If, however, the uplink capacity of the child node is greater than the uplink capacity of the parent node, a swap is performed between the child and parent node as shown by block 308. In a specific example, the swap results in the child becoming a parent of each node that was previously a child of the previous/swapped parent node. A decision is then made as to whether the swapped node has additional parents. If no additional parent exists, the process can end at block 306. If there is an additional parent, the process can repeat beginning at block 302.

One embodiment of the present invention involves a peer replacement operation that is performed at a source of the streaming data. The source S is the only peer that has data at the beginning. Therefore, it is important to make full use of the source uplink capacity to disseminate data to peers as fast as possible. To fully utilize its uplink capacity, S performs Adoption whenever it loses one or more of its current child peers. Adoption is an operation that includes S's passing an adoption offer to one of its direct child peers. A qualified peer in the system is elected in a distributed manner. The elected peer contacts S to become a new child peer of S, thus allowing S efficient usage of its available uplink capacity.

In order to trigger Adoption, S regularly checks the number of its direct child peers. A direct child peer of S is a peer that has a unicast connection to S to receive data packets. Let Nₚ denote the system size determined by the number of peers in the system. Should one of the direct child peers of S leave the system, S will detect its departure. If Nₚ is larger than the maximum number of child peers S can directly support, C_{S}, then S can adopt one of the Nₚ peers as its direct child peer in order to maintain efficient usage of its capacity. If such conditions are met, S passes an adoption offer to one of its child peers, P_{L1}, according to Algorithm 3. P_{L1} will accept the offer if it meets the condition defined in Algorithm 3, a condition that prevents S from adopting a peer that has a large number of descendants. This can be important as an adoption of a peer having a large number of descendants may result in an unbalanced topology once the adoption operation is performed.

In Algorithm 3, a descendant of Peer′ P is a peer that has P as its intermediate peer in the path to S. P_{Li} denotes a child peer of P_{L(i-1)} that has the largest number of descendants at a logical distance of i from S. Thus, P_{L1} represents the child peer of S with the largest number of descendants. To allow P_{Li} to locally process an adoption offer, the algorithm assumes that peers have knowledge about how many peers are present downstream. This knowledge can be obtained by exchanging local information between neighboring peers. When P_{L1} receives S's offer, it checks whether it can take the offer itself by comparing the number of downstream peers to a threshold level. If it is qualified, it accepts the offer by sending an offer acceptance to S. If P_{L1} is not qualified, P_{L1} passes down the offer to one of its child peers, P_{L2}. This procedure is locally performed by P_{Li}, i=1, 2, . . . , as shown in Algorithm 3. This procedure repeats until a peer accepts the offer. When S receives an offer acceptance message from P_{Lk}, a peer that is k logical hops away, it adopts it as a new child peer and starts sending data to Pₗₖ.

Algorithm 3: Process an adoption offer at Peer P_{Li}

Sₜₕᵣₑₛ := [NP CS], the maximum number
of descendants required to accept the offer
Sₓ = The number of downstream peers of Peer x
if S_{Li} < Sₜₕᵣₑₛ then
Send an offer acceptance message to S
else
P_{L(i+1)} arg max_{k={x/Parents(x)=PLi}} Sₖ,
where Parent(x) returns Peer x’s parent
Pass the adoption offer to P_{L(i+1)}

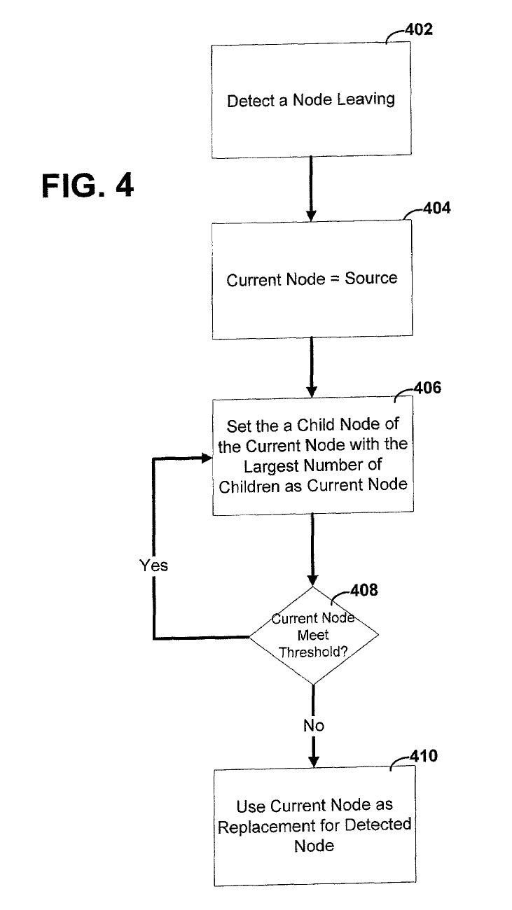

FIG. 4 depicts a flowchart for implementing such an adoption operation, according to one embodiment of the present invention. The source node detects that a node has left at block 402. The current node is set to be the source node at block 404. The current node is changed to one of the immediate child nodes of the current node at block 406. Specifically, the immediate child node can be selected as the child node having the most dependent nodes (i.e., the most subsequent child nodes). A decision is made at block 408 as to whether the current node is meets a threshold value. If the current node does not meet the threshold value, a new current node is selected at block 406 and the process repeats. If the current node does meet the threshold value, block 410 shows that the current node is used to replace that node that was detected as leaving. In a particular instance, the threshold value is the number of children that depend from the current node. This can be particularly useful for balancing the distribution of all nodes in the system relatively evenly between nodes that are direct children of the source node.

The various embodiments discussed herein, used both alone and in combination, can be particularly useful for improving the performance of P2P overlay systems, such as system capacity, end-to-end data transmission delay, and system robustness.

For example, some systems may be using all of the aggregate of the system's peers' uplink capacity. In order to accept a new peer wishing to join the system, the system needs to provide the capacity necessary to deliver the video stream to the peer. Since no (or insufficient) capacity is available, the system cannot accept the new peer, even if the new peer could potentially contribute to the system. Changing the overlay topology to accept the new peer using one of embodiments of the present invention can be useful for expanding the effective capacity, where the effective capacity is relative to the maximum number of peers the system can support.

In some instances, the average end-to-end transmission delay can be decreased. For example, swapping peers according to their uplink capacity may be useful for reducing end-to-end transmission delay and/or the number of logical hops from the source to individual peers can be reduced. The end-to-end transmission delay is the amount of time a data packet is allowed to spend in the network to travel from its origin, the source, to its destination, a peer. A logical hop is either a hop between the source and a peer or a hop between a parent peer and a child peer. The logical hop usually consists of a number of physical links in the underlying physical network. In video streaming, data packets containing a chunk of a video are continuously sent to a user device that is running its video player. The player has a play-out deadline for each video frame, which consists of a number of video packets. If any of the packets belonging to a certain video frame is missing or does not arrive until the frame's play-out deadline, the player cannot play-out the frame. Therefore, reduction in end-to-end delay allows peers to have more time for requesting and receiving missing packets, when packet retransmission is employed for error resilience. Such a time margin effectively increases the overall video quality experienced by peers.

A reduced end-to-end delay can also allow a peer to receive and display the content earlier. The play-out deadline is set to a value large enough to absorb any network congestion and transmission delay of packets in the network. If the transmission delay is reduced, the play-out deadline can also be set to a smaller value accordingly. Such a reduced play-out deadline will bring the received transmission closer in time to the live transmission. This can be useful for live broadcasts and other time-critical applications.

When the source is the only source of the data to be shared among peers and none of the peers are connected to the source, no peers can get data from the system. If the source does not efficiently use its uplink capacity, the probability of all the peers directly connected to the source disconnecting can be relatively high. This situation can result in instability of the system. For instance, some systems employ a leave and rejoin policy to accommodate peer nodes leaving. Such systems may reach a state where no child peers are connected to the source when all the source's child peers leave the system during a time during which no new peers join the system. This can occur, for example, in systems that allow peers to leave the system and attempt rejoin when they do not receive sufficient data packets from their current parent peer. If a peer with many dependent peers leaves the system, then each of the dependent peers may leave the system and attempt to rejoin, effectively losing much of the existing overlay topology. In an extreme case, no peer is connected to the source and there are no peers receiving data packets. This can result in every peer in the system leaving and attempting to rejoin the system, effectively tearing down the existing overlay topology. The various embodiments of the invention can be useful for reducing the possibility of such system tear-down by increasing the use of the source's uplink capacity in order to prevent such system instability.

Various embodiments of the invention can also be useful for improving the error resiliency of the system. Lower end-to-end delay facilitates retransmissions of missing or late data packets. Also, pushing up peers with higher uplink capacity closer to the source causes more peers to be located near the source because peers with higher uplink capacity are able to serve more child peers at the same distance to the source than peers with lower uplink capacity. Such a reduction in the number of logical hops of the data path naturally leads to less frequent disruption of data packet receptions due to ungraceful peer churns, thus providing better error resiliency to peers.

Various implementations are particularly useful for producing an overlay topology that functions in a distributed way with little control from a central authority. The implementations need not be limited to such distributed models and can also be implemented for use in centralized/server-based P2P systems. For instance, various embodiments can be used in systems where a central server controls the overlay construction and maintenance. Such systems include topologies where peers are traditionally only expected to contribute to the system as a form of their network resources such as uplink capacity and their local massive storage such as hard disk drives.

Various changes are possible to the specific protocols and algorithms including tailoring for specific needs of applications which run on top of the overlay. For instance, different and/or additional criteria for swap operations can be considered. Depending on the system complexity, some of the operations can be omitted for a selected subset of peers. For example, peers may have a different set of operations available with respect to their computing power, battery capacity and network connection type. The protocol can be adjusted to allow such heterogeneous peers accordingly.

As an example, a P2P video streaming system is implemented, where peers are usually ordinary end-users using their laptop computers, desktop computers or mobile devices. In order to quickly distribute real-time video content, peers may construct an overlay topology of tree-shape. The root of the tree-shape overlay is a data source and nodes in the overlay are peers. The links between peers are logical connections that are used to receive and forward data from the root to every node in the tree. In this scenario, reconfiguring the tree topology can be especially useful, since peers are heterogeneous in their uplink capacity and video contents are capacity and delay-sensitive.

While the present invention has been described above, and in the claims that follow, those skilled in the art will recognize that many changes may be made thereto without departing from the spirit and scope of the present invention. Such changes may include, for example, the implementation of various embodiments into a variety of possible P2P topologies or the use of different performance metrics. In this regard, the approaches discussed herein generally involve adding and placing peers within the P2P topologies responsive to various criteria, such as desired P2P characteristics. These and other approaches as described in the contemplated claims below characterize aspects of the present invention.

What is claimed is:

1. For use in a peer-to-peer streaming system with a plurality of processing-circuit-peer nodes that share streaming data by passing the streaming data from processing-circuit-parent nodes to processing-circuit-child nodes, a method to modify the system by adding a new processing-circuit-peer node, the method comprising:
responsive to a performance metric for a new processing-circuit-peer node being above a threshold level and a performance metric for an existing processing-circuit-peer node being below the threshold level, a parent processing-circuit-peer node of the existing processing-circuit-peer node removing the existing processing-circuit-peer node from the peer-to-peer streaming system and replacing the existing processing-circuit-peer node with the new processing-circuit-peer node.

2. The method of claim 1, wherein the existing processing-circuit-peer node becomes a child of the new processing-circuit-peer node.

3. The method of claim 1, wherein the threshold level is set according to the uplink capacity necessary to support at least one additional processing-circuit-peer node.

4. The method of claim 1, wherein the threshold level is set according to uplink capacities of currently participating processing-circuit-peer nodes.

5. The method of claim 1, wherein the performance metric is one of latency, uplink capacity and reliability.

6. For use in a peer-to-peer streaming system with a plurality of processing-circuit-peer nodes that share streaming data by passing the streaming data from parent processing-circuit nodes to child processing-circuit nodes, a computer-implemented method for adding a new processing-circuit-peer node to the system, the method comprising:
searching for a processing-circuit-peer node with available upload capacity; and
determining from the search that there is no processing-circuit-peer node with sufficient available upload capacity to provide streaming data to the new processing-circuit-peer node;
determining that the new processing-circuit-peer node has a upload capacity above a threshold capacity; and
in response to the steps of determining,
identifying a leech processing-circuit-peer node that has an upload capacity below the threshold capacity,
contacting a parent processing-circuit-peer node that is a parent of the leech processing-circuit-peer node, and
replacing the leech processing-circuit-peer node with the new node, whereby the new processing-circuit-peer node becomes a child of the parent processing-circuit-peer node.

7. The method of claim 6, wherein the leech processing-circuit-peer node becomes a child of the new processing-circuit-peer node.

8. For use in a peer-to-peer streaming system with a plurality of processing-circuit-peer nodes sharing streaming data by passing the streaming data from parent processing-circuit-peer nodes to child processing-circuit-peer nodes, a method implemented at a parent processing-circuit-peer node having a set of child processing-circuit-peer nodes, the method comprising:
comparing a performance metric of the parent processing-circuit-peer node to a performance metric of a child processing-circuit-peer node of the set of child processing-circuit-peer nodes; and
making the child processing-circuit-peer node of the set of child processing-circuit-peer nodes a parent of the other child peers of the set of child processing-circuit-peer nodes in response to the comparison;
wherein the plurality of processing-circuit-peer nodes share data at fixed transmission rates.

9. For use in a peer-to-peer streaming system with a plurality of processing-circuit-peer nodes sharing streaming data by passing the streaming data from parent processing-circuit nodes to child nodes, a method implemented at a parent processing-circuit-peer node of the plurality of processing-circuit-peer nodes, the method comprising:
detecting a departure of a child processing-circuit-peer node from a parent processing-circuit node, and
responsive to the detection, providing information to other processing-circuit-peer nodes, the provided information used by the other processing-circuit-peer nodes to determine whether or not other processing-circuit-peer nodes are to replace the departed processing-circuit node.

10. For use in a peer-to-peer streaming system with a plurality of processing-circuit-peer nodes sharing streaming data by passing the streaming data from parent nodes to child nodes, a method implemented at a parent processing-circuit-peer node of the plurality of processing-circuit-peer nodes, the method comprising:
detecting a departure of a first child processing-circuit-peer node from the peer-to-peer streaming system, wherein, prior to the departure, the first child processing-circuit-peer node was a child processing-circuit-peer node of the parent processing-circuit-peer node and the first child peer provided data to one or more additional child peers;
responsive to the detected departure, selecting a second child peer to provide data to the one or more additional child peers; and
providing data to the second child peer to facilitate establishment of a connection between the selected child peer and the one or more additional child peers and the parent processing-circuit-peer node.

11. For use in a peer-to-peer streaming system with a plurality of computer-based peer nodes that share streaming data by passing the streaming data from parent computer-based nodes to child computer-based nodes, an arrangement of computer-based nodes, comprising:
an existing child computer-based-peer node;
a new child computer-based peer node; and
a parent computer-based peer node of the existing child computer-based peer node configured and arranged to, in response to a performance metric for the new child computer-based peer node being above a threshold level and a performance metric for the existing child computer-based peer node being below the threshold level,
remove the existing child computer-based peer node from the peer-to-peer streaming system, and
replace the existing child computer-based peer node with the new child computer-based peer node.

12. For use in a peer-to-peer streaming system with a plurality of computer-based peer nodes sharing streaming data by passing the streaming data from parent computer-based nodes to child computer-based nodes, an arrangement of computer-based nodes, comprising:
computer-based nodes configured and adapted to implement, at a parent computer-based peer node of the plurality of computer-based peer nodes, the method including detecting a departure of a first child computer-based peer node from the peer-to-peer streaming system, wherein, prior to the departure, the first child computer-based peer node was a child computer-based peer node of the parent computer-based peer node and the first child computer-based peer node provided data to one or more additional child computer-based peer nodes;
responsive to the detected departure, selecting a second child computer-based peer node to provide data to the one or more additional child computer-based peer nodes; and
providing data to the second child computer-based peer node to facilitate establishment of a connection between the selected child computer-based peer node and the one or more additional child computer-based peer nodes and the parent computer-based peer node.
